(19) United States
(12) Patent Application Publication
(10) Pub. No.: US 2002/0140560 A1
(43) Pub. Date: Oct. 3, 2002

(54) Method and apparatus for providing information to a mobile consumer

(76) Inventors: Todd M. Altman, Phoenix, AZ (US); Sean P. Maloney, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,458

(22) Filed: Mar. 30, 2001

(51) Int. Cl. G08B 23/00

(52) U.S. Cl. 340/573.1; 340/988; 340/995; 340/539

(57) ABSTRACT

Briefly, in accordance with one embodiment of the invention, a mobile user may use a portable communication device to request consumer information based on the location of the user relative to the location of a vendor.

### BACKGROUND

With the pervasiveness of portable communication devices such as, for example, cell phones, personal digital assistants (PDA's), lap top computers, etc., individuals have become more mobile. Consequently, individuals are more likely to be in locations that they are not as familiar with. Accordingly, the individuals may not know where to find particular services such as, for example, gas, food, lodging, etc.

Thus, there is a need for better ways to provide consumer information to mobile users.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a system that may be used to request or receive consumer information in accordance with an embodiment of the present invention; and

FIG. 2 is a flow chart of a method in accordance with an embodiment of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

It should be understood that the present invention may be used in a variety of applications. Although the present invention is not limited in this respect, the method disclosed herein may be used in conjunction with apparatuses that include a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's) and the like.

Types of cellular radiotelephone communication systems intended to be within the scope of the present invention include, although not limited to, Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like.

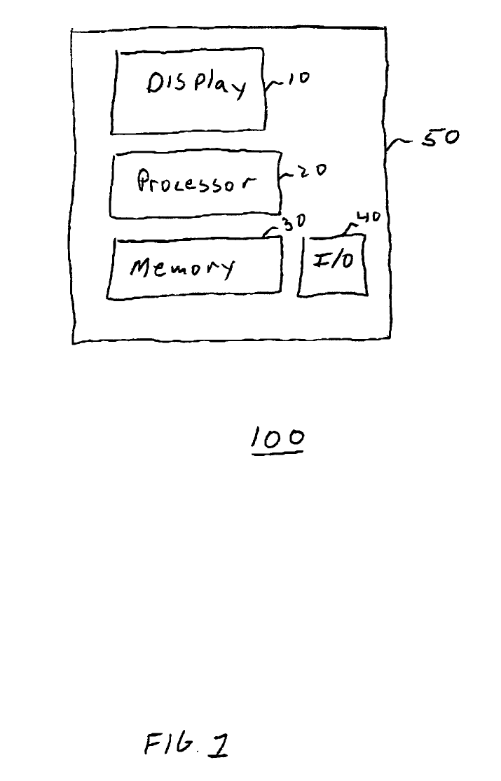

Turning to FIG. 1, an embodiment 100 in accordance with the present invention is described. Embodiment 100 may comprise a portable communication device 50 that may be used to request or receive consumer information. Although the scope of the present invention is not limited in this respect, portable communication device 50 may comprise a processor 20, a display 10, memory 30, and input/output (I/O) module 40. As explained in more detail below, processor 20 may be used to request consumer information based on user preferences inputted by I/O module 40 and stored in memory 30. The results of the request may be provided to the user through display 10, although the scope of the present invention is not limited in this respect to this example.

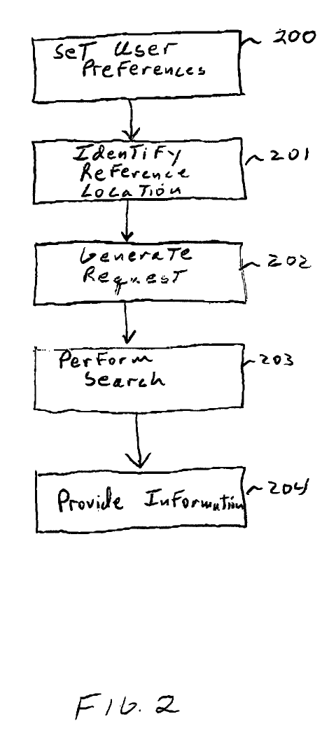

Referring to FIG. 2, an embodiment in accordance with the present invention is described. Simply stated, embodiments of the present invention may allow a user of a mobile communication device to request consumer information based on their current or anticipated location relative to service vendors. For example, a user may be able to request a service (i.e. nearest location of a gas station) and receive directions to that location. Alternative embodiments may be used by vendors to notify consumers within some proximity to the vendor of the availability of a particular service. For example, a theater may notify customer within 10 miles of the theater that there are discounted tickets available for an upcoming show.

The types or services that may be requested by a consumer or offered by a vendor may include a variety of types of consumer information. For example, the services may be related to vendors that provide goods, lodging, food, or services. Although the scope of the present invention is not limited in this respect, some examples of services include providing entertainment information (i.e., movies, shows, concerts, etc), health services (i.e. doctors, hospitals, pharmacies, etc.), emergency services (i.e., police, fire, security, etc.), travel services (i.e. train schedules, bus schedules, gas station locations, traffic status, etc.). Additionally, alternative embodiments of the present invention may include consumer information that a vendor may desire to inform consumers or (i.e., sales). Although this list is not meant to be exhaustive.

Embodiments of the present invention may involve the use of a portable device such as a mobile communication device (e.g., cell phone), a two-way radio communication system, a one-way pager, a two-way pager, a personal communication system (PCS), a portable computer, or the like. Although it should be understood that the scope and application of the present invention is in no way limited to these examples.

The method may begin with a user of a portable communication device specifying particular user preferences for the type and/or nature of the consumer information that the user may be interested in receiving, step 200. Simply stated, the user may desire to select criteria that may be used to filter or condition the type of information that is provided to the user. For example, the portable communication device may use a processor to execute a computer program that allows the user to indicate particular preferences. This information may then be stored in volatile or non-volatile memory for future use. Additionally, the information may be updated prior to each request or the same data may be used for most or all requests.

Although the scope of the present invention is not limited in this respect, the user may select a limit or range of acceptable prices for a service (e.g. how much they are willing to pay for gasoline). The user may also set preferences for how far they are willing to travel from their current or expected location in order to get the service (e.g. the user may only be interested in gas stations that are 5 miles from their current location or some distance from home, work, etc.). The user may also select preferences for particular vendors for a services or some threshold for a minimum level of quality (e.g. a three-star hotel or particular chain of gas stations, hotels, etc.). It should be understood, however, that the use of user preferences is considered optional.

To initiate a request for a service or for consumer information, the user may identify or describe a reference location, step 201. The reference location may be the current location of the user or of the portable communication device. Alternative, the reference location may be another location of interest to the user or a location that the user may be at in the future. For example, the user may indicate an interest in information relative to their work or home. The reference location may be used to condition the request so that services or vendors that are within proximity of the reference location are provided to the user. For example, only gas stations within 5 miles of the portable communication device (i.e., reference location) are presented to the user.

The actual reference location may be determined using a variety of techniques. Although the scope of the present invention is not limited in this respect, the reference location of the portable communication device (e.g. device 50) may be determined by a global positioning satellite (GPS) service. Alternatively, the position of the portable device may be determined through a triangulation or tracking system with a wireless communication service.

As mention above, the user may also chose to enter a specific location of interest. For example, the user could input a location into the portable location device, such as his home, office, school, etc. In doing so, the user may enter an address with which the actual physical location may be determined. Alternatively, the user may simply enter the coordinates of the location of interest. In either event, the scope of the present invention is not limited to the particular technique used to determine the reference location.

The user may than make a request for service or consumer information, step 202. The request may be for any service, such as for food, lodging, goods, etc. within some proximity to the user, although the scope of the present invention is not limited in this respect. The request may also involve the use of user defined preferences as criteria for the information. For example, the request may specify an acceptable distance from the portable communication device, a maximum price or price range for the service, or a particular level of quality.

Databases coupled to the communication system may then be searched to determine if any services meet the request of the user, step 203. Although the scope of the invention is not limited in this respect, services providers (i.e., cellular communication system providers may process the request and search their own data bases or other databases available through networks such as the internet to determine is any vendors meet the requirements specified by the user. As mentioned earlier, the user may only be provided with the location or information associated with vendors that are within a particular proximity to the user or portable communication device (i.e. reference location).

If a match is found, that information is provided to the user, step 204. For example, the user may be provided with the information through a wireless communication to the portable communication device. Additionally, the user may also be provided with details associated with the vendor such as hours of operation, cost, directions to the vendor, etc., although the scope of the present invention is not limited in this respect. Thus, with particular embodiments of the present invention, a user of a mobile communication device may be provided with information associated with a variety of services. Moreover, the user may be able to be provided with this information real-time as the location of the user changes with time.

In an alternative embodiment, vendors may be able to provide solicited or unsolicited consumer information to those consumers who may be within proximity to that particular vendor. For example, a vendor may be able to advertise to consumers within a predetermined distance and the audience of potential consumers may change with time as mobile users move within the predetermined distance. Such as system may be desirable to offer a service (i.e., food, lodging, goods, etc.) to users. For example, a theatre may be able to broadcast or transmit last minute advertising for discounted ticket prices on an upcoming show or event.

Although the scope of the present invention is not limited in this respect, a user may adjust the user defined settings to enable the type of information that would be of interest. A vendor may then send consumer information to those users who meet certain criteria (i.e. satisfy particular user preferences, distance from vendor, etc.). Such a system may be desirable to notify users of last minute information (i.e. sales, cancellations, price changes, traffic issues, etc.).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
identifying a reference location; and
providing consumer information determined at least in part on a vendor's proximity to the reference location;

2. The method of claim 1, wherein providing consumer information includes providing consumer information determined at least in part on user defined preferences.

3. The method of claim 1, wherein providing consumer information includes providing consumer information through a wireless communication.

4. The method of claim 1, wherein identifying the reference location includes determining the current location of a user.

5. The method of claim 4, wherein determining the location of a user includes determining the location of a portable communication device with a global position satellite system.

6. The method of claim 1, wherein identifying consumer information includes inputting a location into a portable communication device.

7. The method of claim 1, further comprising requesting a service in proximity to a portable communication device.

8. The method of claim 7, wherein requesting a service includes specifying an acceptable distance from the portable communication device for the service.

9. The method of claim 7, wherein requesting a service includes specifying an acceptable price for the service.

10. The method of claim 7, wherein requesting a service includes specifying an acceptable quality level for the service.

11. The method of claim 7, wherein requesting a service includes requesting a service from the group consisting of food, lodging, and goods.

12. The method of claim 1, further comprising transmitting an offer of a service to a portable communication having a reference location that is within proximity to a vendor.

13. The method of claim 12, wherein transmitting an offer of a service includes offering a service from the group consisting of food, lodging, and goods.

14. The method of claim 1, further comprising providing directions from the reference location to a vendor associated with the consumer information.

15. The method of claim 1, further comprising providing directions from a portable communication device to a vendor associated with the consumer information.

16. A method of providing consumer information comprising:
determining a reference location;
requesting a service from a portable communication device;
providing consumer information to the portable communication device, the consumer information determined at least in part on the distance of a vendor to the reference location.

17. The method of claim 16, wherein requesting a service includes requesting location of a gas station.

18. The method of claim 16, further comprising identifying user preferences for the service.

19. The method of claim 16, further comprising providing directions from the vendor to the reference location.

20. A portable communication device adapted to request a service based on the location of the portable communication device.

21. The portable communication device of claim 20, wherein the portable communication device is further adapted to request a service based on user defined preferences.

22. The portable communication device of claim 21, wherein the portable communication device is further adapted to provide directions from the location of the portable communication device to the location of the service.
